(19) United States
(12) Patent Application Publication
(10) Pub. No.: US 2013/0200845 A1
(43) Pub. Date: Aug. 8, 2013

(54) CHARGING/DISCHARGING CONTROL APPARATUS

(71) Applicant: SUZUKI MOTOR CORPORATION, Shizuoka (JP)

(72) Inventor: Seiji BITO, Shizuoka (JP)

(73) Assignee: SUZUKI MOTOR CORPORATION, Shizuoka (JP)

(21) Appl. No.: 13/733,929

(22) Filed: Jan. 4, 2013

(30) Foreign Application Priority Data
Feb. 3, 2012 (JP) 2012-022046

(51) Int. Cl. H02J 7/00

(52) U.S. Cl. CPC H02J 7/0042
USPC 320/109

(57) ABSTRACT

A hybrid electric vehicle 1 has a battery state detecting unit for detecting a temperature and SOC of a battery pack, a storage unit for storing a first target SOC calculation map in which a battery temperature and a target SOC which enables regenerative power generation at that battery temperature are associated with each other, and a second target SOC calculation map in which a battery temperature and a target SOC which enables startup of an internal combustion engine at that battery temperature are associated with each other, and a charging/discharging control unit for acquiring a target SOC which corresponds to the detected battery temperature based on the first target SOC calculation map or the second target SOC calculation map to control charging/discharging so that the detected SOC matches the acquired target SOC.

### TECHNICAL FIELD

The present invention relates to a technology of controlling the charging/discharging of a battery mounted in a hybrid electric vehicle (HEV) or a plug-in hybrid electric vehicle (PHEV) having an engine (for example, a high voltage battery).

### BACKGROUND ART

A hybrid electric vehicle or a plug-in hybrid electric vehicle uses electric power from a battery so as to make an engine start by driving a starter motor, so the state of the battery (State of Charge (SOC), temperature, voltage, etc.) greatly affect the engine startup characteristic.

In addition, in a hybrid electric vehicle and plug-in hybrid electric vehicle in which regenerative braking is possible, the braking ability at the time of regenerative power generation depends on the state of the battery. For this reason, in such a hybrid electric vehicle and a plug-in hybrid electric vehicle, an expensive and complicated system such as coordinated regenerative braking becomes necessary.

Further, when the battery temperature is a low temperature or when the SOC is low, the discharge power of the battery remarkably falls. For this reason, to secure the engine startup ability when the battery temperature is a low temperature or when the SOC is low, the hybrid electric vehicle has to mount a large capacity battery.

Here, the technology disclosed in Patent Document 1 controls charging/discharging of a battery by a charger so as to secure a braking force accompanied with regenerative braking at all times in an electric vehicle or a plug-in hybrid electric vehicle.

### PATENT DOCUMENT

Patent Document 1: JP 2001-36070 A

### SUMMARY OF THE INVENTION

### Problems to be Solved

In this regard, a hybrid electric vehicle or a plug-in hybrid electric vehicle has to be started by the battery power at the time of the start of operation of the vehicle-mounted engine, etc. (that is, a motor driven by the electric power from a battery).

However, the technology disclosed in Patent Document 1 can secure the braking force when applied to a hybrid electric vehicle or to a plug-in hybrid electric vehicle, but the battery power may not be enough to start up an engine. That is, the technology disclosed in Patent Document 1 may be unable to achieve both securing of the braking force accompanied with regenerative power generation and engine startup.

Therefore, an object of the present invention is to enable both securing of the braking force accompanied with regenerative power generation and engine startup to be achieved.

### Solution to the Problem

To solve this problem, according to an aspect of the present invention, there is provided a charging/discharging control apparatus for controlling charging/discharging of a battery in a vehicle having a first motor connected to an internal combustion engine to start the internal combustion engine and driven by the internal combustion engine to generate power, a battery for storing the power from the first motor, and a second motor connected to the drive wheels to drive the drive wheels with the power from the first motor or the battery and to generate a braking force at the drive wheels for regenerative power generation, the charging/discharging control unit comprising: a temperature detecting unit for detecting a temperature of the battery;

an SOC detecting unit for detecting a State Of Charge) of the battery; a storage unit for storing a first map in which a battery temperature and a target SOC for enabling the regenerative power generation at the battery temperature are associated with each other, and a second map in which the battery temperature and a target SOC for enabling startup of the internal combustion engine at the battery temperature are associated with each other; and a charging/discharging control unit for acquiring the target SOC associated with the battery temperature detected by the temperature detecting unit based on the first map or the second map, and for controlling charging/discharging so that the SOC detected by the SOC detecting unit matches the acquired target SOC.

The above charging/discharging control apparatus may further comprise an internal combustion engine startup prohibiting unit for prohibiting the startup of the internal combustion engine at the time of a low SOC, wherein the internal combustion engine startup prohibiting unit may acquire the target SOC associated with the battery temperature detected by the temperature detecting unit based on the first map or the second map, and may allow the startup of the internal combustion engine when charging by the charging/discharging control is performed so that the SOC detected by the SOC detecting unit matches the acquired target SOC.

In the above charging/discharging control apparatus, between said first map and said second map, there may be a part having a relationship in which the target SOC of the first map becomes larger than the target SOC of the second map, the storage unit further stores a third map in which the battery temperature and a target SOC smaller than the target SOC of the first map and larger than the target SOC of the second map are associated with each other, and the charging/discharging control unit may control charging/discharging to acquire the target SOC associated with the battery temperature detected by the temperature detecting unit based on the third map, and the SOC detected by the SOC detecting unit matches the acquired target SOC, when the SOC detected by the SOC detecting unit is smaller than the target SOC of the first map and is larger than the target SOC of the second map.

In the above charging/discharging control apparatus, the first map and the second map may intersect so that the target SOC of the first map becomes smaller than the target SOC of the second map in a first temperature region where the battery temperature is low, and the target SOC of the first map becomes larger than the target SOC of the second map in a second temperature region where the battery temperature is higher than the first temperature region, and in the third map, the battery temperature of the second temperature region and the target SOC smaller than the target SOC of the first map and is larger than the target SOC of the second map may be associated with each other.

### Advantageous Effects of the Invention

According to an aspect of the present invention, by controlling charging/discharging based on the first map which enables regenerative power generation and the second map which enables startup of the internal combustion engine, both of the secured vehicle braking force accompanied with the regenerative power generation and the startup of the internal combustion engine can be achieved.

According to an aspect of the present invention, it is possible to prohibit the startup of the internal combustion engine at the time of a low SOC for preventing deterioration of the battery, only when using the internal combustion engine to drive the first motor and charge the battery. Accordingly, according to an aspect of the present invention, it is possible to keep down the frequency of allowing startup of the internal combustion engine at the time of a low SOC and keep down deterioration of the battery.

According to an aspect of the present invention, when the SOC detected by the SOC detecting unit takes a value between the target SOC of the first map and the target SOC of the second map, it is possible to use a third map and control charging/discharging while using a target SOC with an extra margin for regenerative power generation and startup of the internal combustion engine as the control target.

According to an aspect of the present invention, when the battery temperature is relatively high and the SOC detected by the SOC detecting unit takes a value between the target SOC of the first map and the target SOC of the second map, it is possible to use a third map and control charging/discharging while using a target SOC with an extra margin for regenerative power generation and startup of the internal combustion engine as the control target. Additionally, according to an aspect of the present invention, when the battery temperature is relatively low and the SOC detected by the SOC detecting unit takes a value between the target SOC of the first map and the target SOC of the second map, it is possible to use the second map and control charging/discharging while using a target SOC which enables startup of the internal combustion engine as the control target. Therefore, according to an aspect of the present invention, it becomes possible to secure engine startup which tends to be insufficient at the time of a low battery temperature. As a result, according to an aspect of the present invention, for example, it is possible to reduce the size of the battery while securing necessary performance.

### BRIEF DESCRIPTION OF THE DRAWINGS

FIG. 1 is a view showing a system configuration of a series type hybrid electric vehicle of a present embodiment;

FIG. 2 is a view showing an example of the configuration of a vehicle controller;

FIG. 3 is a flowchart showing one example of content of processing of battery protection control;

FIG. 4 is a flowchart showing one example of content of processing of optimal charge control at the time of a charging mode;

FIG. 5 is a view showing one example of a first target SOC calculation map and a second target SOC calculation map;

FIG. 6 is a view explaining charging control when the detected SOC is present in a region B;

FIG. 7 is a view explaining charging control when the detected SOC is present in a region C;

FIG. 8 is a view explaining charging control when the detected SOC is present in a region D;

FIG. 9 is a view explaining charging control when the detected SOC is present in a region A;

FIG. 10 is a flowchart showing one example of processing in a sleep mode;

FIG. 11 is a flowchart showing one example of content of processing in optimal charge control at the time of a READY state; and

FIG. 12 is a view showing one example of a time chart at the time of optimal charge control.

### DESCRIPTION OF EMBODIMENTS

Embodiments of the present invention will be explained while referring to the drawings.

The present embodiment is a series type hybrid electric vehicle.

### (Configuration)

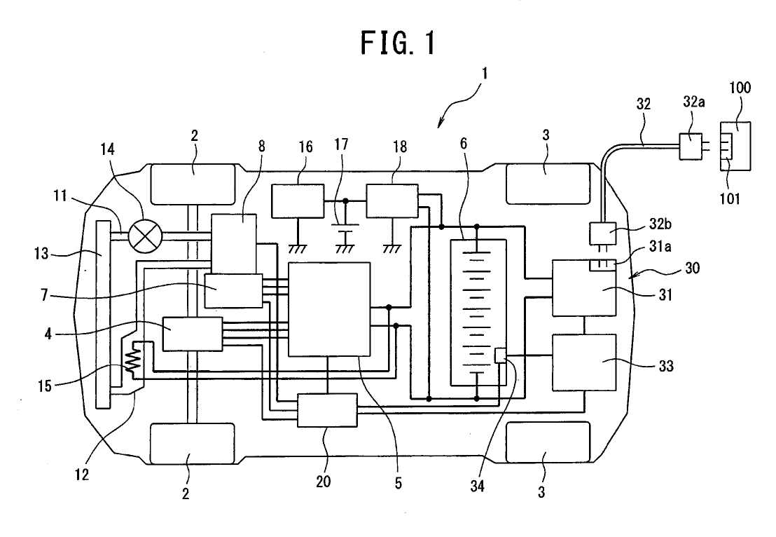

FIG. 1 is a view showing one example of a system configuration of a series type hybrid electric vehicle as an electric vehicle (hereinafter, simply referred to as “hybrid electric vehicle”) 1. This hybrid electric vehicle 1 is a plug-in hybrid electric vehicle which enables a commercial power source to charge a vehicular mounted battery pack 6.

As shown in FIG. 1, the hybrid electric vehicle 1 is provided with: a drive motor 4 which is connected to front wheels (drive wheels) 2 of front and rear wheels 2, 3 and which functions as a generator in addition to a drive source; an inverter 5 which performs control for driving the drive motor 4; a battery pack (specifically, a high voltage battery) 6 that is a secondary cell; a generator 7 which is connected to an engine 8 to charge the battery pack 6 and which also functions as a starter motor; an engine (specifically, an internal combustion engine) 8 for driving the generator 7; and a vehicle controller 20 which controls the drive motor 4, inverter 5, generator 7, and engine 8.

Further, the hybrid electric vehicle 1 is provided with a charging unit 30 which charges the battery pack 6 by an outside power source 100. The charging unit 30 is provided with: a charger 31 which supplies the electric power to be input thereinto to the battery pack 6 so as to charge the battery pack 6; a charging cable 32 which can be connected to the charger 31 and to the outside power source 100, and which connects the charger 31 and outside power source 100; a charging control unit 33 which controls the charger 31; and a battery state detecting unit 34 which can detect the state of the battery pack 6.

Here, the “state of the battery pack 6” includes, for example, values of the temperature, voltage, current, and SOC (State of Charge). In addition, the charging cable 32 is provided with: a terminal 32a which can be connected to an output terminal 101 of the outside power source 100; and a terminal 32b which can be connected to an input terminal 31a of the charger 31. When detecting that this charging cable 32 connect the charger 31 and the outside power source 100, the charging control unit 33 becomes a charging mode in which the battery pack 6 is charged by the electric power from the outside power source 100. This charging control unit 33 communicates with the vehicle controller 20 to exchange information and operate in a coordinated fashion.

Further, the hybrid electric vehicle 1 is provided with: a radiator 13 which is communicated with the engine 8 by a coolant outlet tube 11 and a coolant inlet tube 12 and which cools the engine coolant; a water pump 14 which is arranged in the pathway of the coolant outlet tube 11 and which circulates the engine coolant; and an electric type heater 15 which is arranged in the pathway of the coolant inlet tube 12 to warm the engine coolant.

Here, the electric type heater 15 is, for example, a PTC heater. The electric type heater 15 operates with the power source of the battery pack 6 and thereby warms the engine coolant which is introduced to the engine 8.

In addition, the hybrid electric vehicle 1 is provided with: a vehicle-mounted electric load (for example, 12V load) 16; a low voltage battery 17 for driving the electric load 16; and a DC-DC converter 18 for converting the voltage from the battery pack 6 to a voltage for the low voltage battery.

Next, an example of the control to be performed by the vehicle controller 20 will be explained.

Here, the vehicle controller 20 is, for example, an ECU (Electronic Control Unit) provided with a microcomputer and its peripheral circuits. For example, the vehicle controller 20 is configured with a CPU, ROM, RAM, etc. Further, the ROM stores one or more programs for realizing various types of processing. The CPU runs the various types of processing in accordance with one or more programs stored in the ROM.

Such a vehicle controller 20 uses the electric power from the battery pack 6 as a drive source to drive the drive motor 4 and make the front wheels 2 rotate so as to drive the vehicle. Moreover, at the time of deceleration, the vehicle controller 20 causes the rotation of the front wheels 2 to drive the drive motor 4 and to make the drive motor 4 function as a generator for regenerative braking. This makes the hybrid electric vehicle 1 generate a braking force, recovers kinetic energy as electric energy, and charges the battery pack 6.

Additionally, the vehicle controller 20 causes the engine 8 to drive the generator 7 so as to charge the battery pack 6. Further, the vehicle controller 20 causes the electric power from the battery pack 6 to make the generator 7 operate as a drive motor so as to make the engine 8 turn (motoring).

Furthermore, when the battery voltage of the battery pack 6 is equal to or lower than a certain constant voltage, the vehicle controller 20 prohibits startup of the engine 8 performed by driving the generator 7 as a starter motor and protects the battery pack 6 in battery protection control.

Further, at the time of the charging mode, the vehicle controller 20 sets the SOC of the battery pack 6 at an optimal value by optimal charge control. Further, even when in the READY state, the vehicle controller 20 causes optimal charge control to make the SOC of the battery pack 6 at an optimal value.

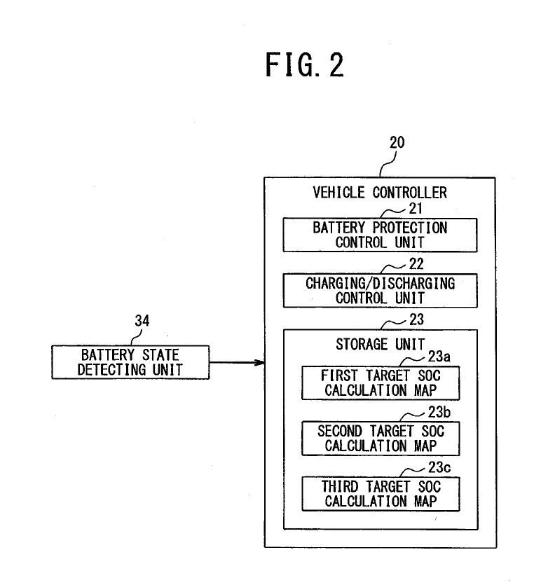

FIG. 2 is a view showing an example of the configuration of the vehicle controller 20 for realizing the battery protection control and optimal charge control as described above.

As shown in FIG. 2, the vehicle controller 20 is provided with: a battery protection control unit 21 for performing battery protection control; a charging/discharging control unit 22 for performing optimal charge control or other charging/discharging control; and a storage unit 23 in which various types of data are stored. The storage unit 23 is, for example, the above-mentioned ROM, RAM, etc. This storage unit 23 stores first to third target SOC calculation maps 23a, 23b, and 23c to be described later.

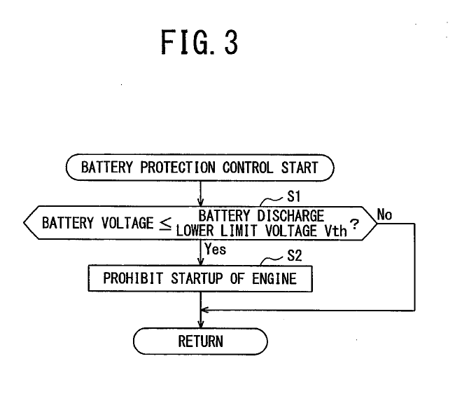

FIG. 3 is a flow chart showing one example of the content of processing of the battery protection control performed by the battery protection control unit 21.

As shown in FIG. 3, firstly, at step S1, the battery protection control unit 21 determines whether or not the battery voltage V detected by the battery state detecting unit 34 is equal to or lower than a battery discharge lower limit voltage Vth. Here, the “battery discharge lower limit voltage Vth” is, for example, a value set experimentally, empirically, or theoretically. Further, the battery discharge lower limit voltage Vth is, for example, set based on the battery temperature. For example, the lower the battery temperature is, the larger the battery discharge lower limit voltage Vth is set.

Due to this step S1, when the battery protection control unit 21 determines that the battery voltage V is equal to or lower than the battery discharge lower limit voltage Vth (V≦Vth), processing proceeds to step S2. Further, when the vehicle controller 20 determines that the battery voltage V is larger than the battery discharge lower limit voltage Vth (V>Vth), processing shown in FIG. 3 terminates.

The hybrid electric vehicle 1, with the use of the battery production control which the battery protection control unit 21 performs, prevents the battery voltage from becoming extremely low and the battery pack 6 from deteriorating, caused by the fact that the generator 7 is driven by the electric power supplied from the battery pack 6 to start the engine 8.

Next, the optimal charge control which the charging/discharging control unit 22 performs at the time of the charging mode will be explained.

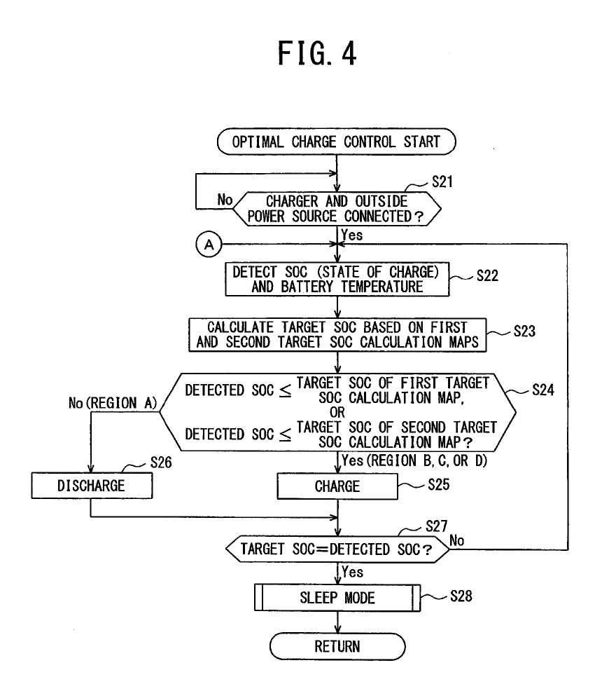

FIG. 4 is a flow chart showing one example of the content of processing of the optimal charge control.

As shown in FIG. 4, firstly, at step S21, the charging/discharging control unit 22 determines whether or not the charger 31 and the outside power source 100 are connected by the charging cable 32. For example, when detecting that the input terminal 31a of the charger 31 is connected with the terminal 32b of the charging cable 32 and that the output terminal 101 of the outside power source 100 is connected with the terminal 32a of the output terminal 101, the charging/discharging control unit 22 determines that the charger 31 and the outside power source 100 are connected by the charging cable 32. When the charging/discharging control unit 22 determines the charger 31 and the outside power source 100 are connected by the charging cable 32, processing proceeds to step S22.

At step S22, the charging/discharging control unit 22 detects the SOC (detected SOC) and battery temperature based on the detected value of the battery state detecting unit 34.

Next, at step S23, the charging/discharging control unit 22 calculates the target SOC based on the first target SOC calculation map 23a and the second target SOC calculation map 23b which are stored at the storage unit 23.

Here, the first target SOC calculation map 23a and the second target SOC calculation map 23b are both maps in which the battery temperature and the target SOC are associated with each other. Further, the first target SOC calculation map 23a is a map in which the target SOC which enables the regenerative power generation to be necessary as the braking force (that is, which enables charging of the regenerated electric power at the time of braking) is associated with the battery temperature. That is, the target SOC of the first target SOC calculation map 23a is a value such that when the SOC of the battery pack 6 becomes larger than the target SOC, the regenerative power generation becomes difficult. Further, the second target SOC calculation map 23b is a map in which the target SOC for not failing in engine startup is associated with the battery temperature. That is, the target SOC of the second target SOC calculation map 23b is a value such that when the SOC of the battery pack 6 becomes smaller than the target SOC, startup of the engine 8 becomes difficult.

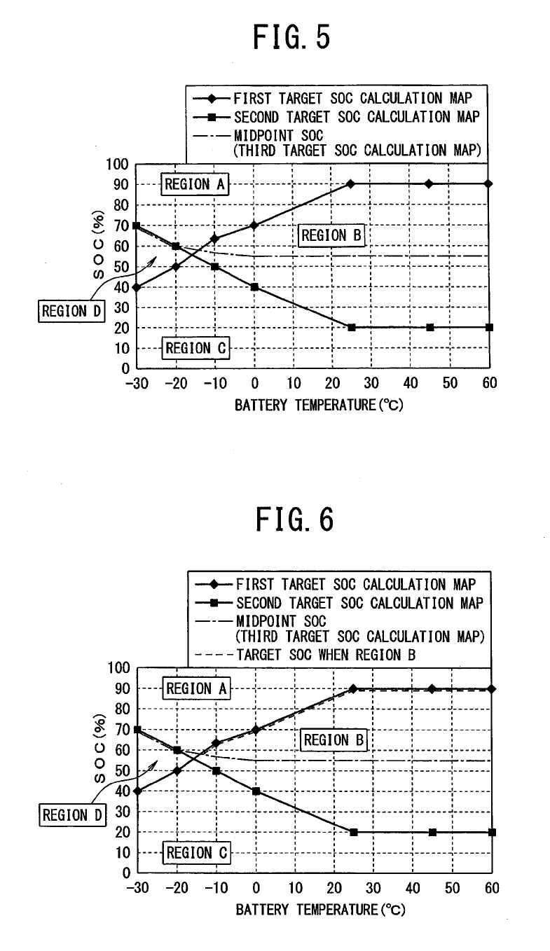

FIG. 5 is a view showing one example of such a first target SOC calculation map 23a and second target SOC calculation map 23b.

In FIG. 5, the first target SOC calculation map 23a becomes a map which is shown by the black diamond marks and which includes a relationship between the battery temperature and the target SOC. Further, in FIG. 5, the second target SOC calculation map 23b becomes a map which is shown by the black square marks and which includes a the relationship between the battery temperature and the target SOC.

In the first target SOC calculation map 23a, at the temperature region where the battery temperature is low (first temperature region), when the battery temperature becomes higher, the target SOC becomes larger. If the battery temperature exceeds such a low temperature region, regardless of the battery temperature, the target SOC becomes a constant value. In addition, in the second target SOC calculation map 23b, at the temperature region where the battery temperature is low, when the battery temperature becomes higher, the target SOC becomes smaller. If the battery temperature exceeds such a low temperature region, regardless of the battery temperature, the target SOC becomes a constant value. Further, the target SOC of the first target SOC calculation map 23a becomes smaller than the target SOC of the second target SOC calculation map 23b, when the battery temperature is the minimum temperature (-30° C.) defined by the first target SOC calculation map 23a. Accordingly, in general, the target SOC of the first target SOC calculation map 23a is larger than the target SOC of the second target SOC calculation map 23b as a whole, but the first target SOC calculation map 23a and the second target SOC calculation map 23b intersect near the minimum temperature of the battery temperature. At such an intersecting battery temperature (hereinafter, referred to as “intersecting battery temperature”) or lower (in the first temperature region), the target SOC of the first target SOC calculation map 23a becomes smaller than the target SOC of the second target SOC calculation map 23b.

Accordingly, as shown in FIG. 5, as the regions defined by the first target SOC calculation map 23a and the second target SOC calculation map 23b, the region A, region B, region C, and region D are obtained.

Here, the region A becomes the region where, at the battery temperature region of the intersecting battery temperature or lower (that is, first temperature region), the SOC becomes equal to or higher than the target SOC of the second target SOC calculation map 23b and, at the battery temperature region higher than the intersecting battery temperature (that is, second temperature region), the SOC becomes equal to or higher than the target SOC of the first target SOC calculation map 23a. In addition, the region B becomes the region where the battery temperature is higher than the intersecting battery temperature and which is surrounded by the first target SOC calculation map 23a and the second target SOC calculation map 23b. Further, the region C becomes the region where, at the battery temperature region of the intersecting battery temperature or lower, the SOC becomes equal to or lower than the target SOC of the first target SOC calculation map 23a and, at the battery temperature region higher than the intersecting battery temperature, the SOC becomes equal to or lower than the target SOC of the second target SOC calculation map 23b. Moreover, the region D becomes the region where the battery temperature is lower than the intersecting battery temperature and which is surrounded by the first target SOC calculation map 23a and the second target SOC calculation map 23b.

The charging/discharging control unit 22 refers to these first target SOC calculation map 23a and second target SOC calculation map 23b, and acquires the target SOC corresponding to the battery temperature detected at step S22.

Next, at step S24, the charging/discharging control unit 22 determines whether or not the detected SOC is equal to or lower than the target SOC calculated based on the first target

SOC calculation map 23a at step S23 or whether or not the detected SOC is equal to or lower than the target SOC calculated based on the second target SOC calculation map 23b at step S23. When the charging/discharging control unit 22 determines that the detected SOC is equal to or lower than the target SOC calculated based on the first target SOC calculation map 23a or that the detected SOC is equal to or lower than the target SOC calculated based on the second target SOC calculation map 23b, processing proceeds to step S25. Further, when the charging/discharging control unit 22 determines that the detected SOC is not equal to or lower than the target SOC calculated based on the first target SOC calculation map 23a and that the detected SOC is not equal to or lower than the target SOC calculated based on the second target SOC calculation map 23b, processing proceeds to step S26.

At step S25, the charging/discharging control unit 22 causes the charger 30 to charge the battery pack 6. In addition, the charging/discharging control unit 22 proceeds the processing to step S27.

Here, the charging/discharging control unit 22 performs charging so that the detected SOC becomes the target SOC. FIG. 6 to FIG. 8 are views for explaining the charging.

As shown in FIG. 6, the charging/discharging control unit 22 performs charging until the detected SOC becomes the target SOC of the first target SOC calculation map 23a (target SOC shown by broken lines in FIG. 6) when the detected SOC is present in the region B.

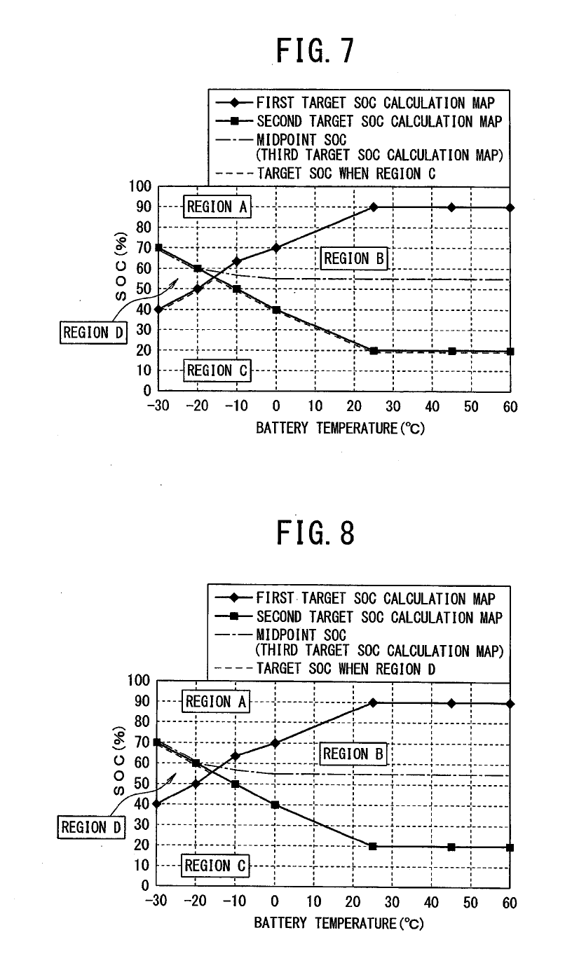

Further, as shown in FIG. 7, when the detected SOC is present in the region C, the charging/discharging control unit 22 performs charging so that when the battery temperature at the time of detection of the detected SOC is equal to or lower than the intersecting battery temperature, the detected SOC becomes the target SOC of the first target SOC calculation map 23a (target SOC shown by broken line in FIG. 7), and so that when the battery temperature at the time of detection of the detected SOC is higher than the intersecting battery temperature, the detected SOC becomes the target SOC of the second target SOC calculation map 23b (target SOC shown by broken line in FIG. 7).

Further, as shown in FIG. 8, when the detected SOC is present in the region D, the charging/discharging control unit 22 performs charging until the detected SOC becomes the target SOC of the second target SOC calculation map 23b (target SOC shown by broken line in FIG. 8).

At step S26, the charging/discharging control unit 22 discharges the battery pack 6. Then, the charging/discharging control unit 22 proceeds the processing to step S27.

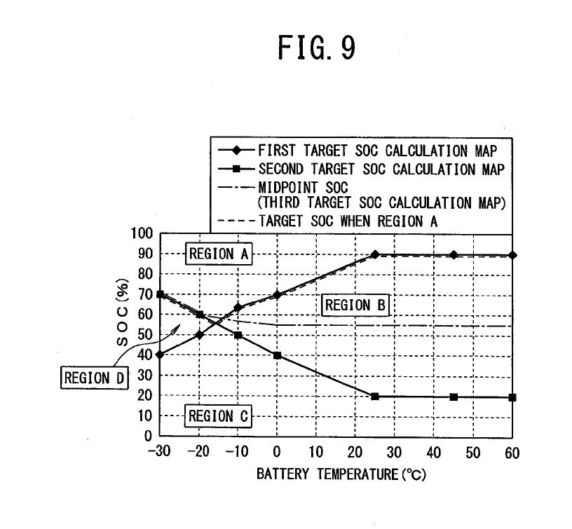

Here, the charging/discharging control unit 22 performs discharging so that the detected SOC becomes the target SOC. FIG. 9 is a view for explaining the discharging.

As shown in FIG. 9, the charging/discharging control unit 22 performs discharging so that when the battery temperature at the time of detection of the detected SOC is equal to or lower than the intersecting battery temperature, the detected SOC becomes the target SOC of the second target SOC calculation map 23b (target SOC shown by a broken line in FIG. 9). Further, the charging/discharging control unit 22 performs discharging so that when the battery temperature at the time of detection of the detected SOC is higher than the intersecting battery temperature, the detected SOC becomes the target SOC of the first target SOC calculation map 23a (target SOC shown by broken line in FIG. 9). For example, the charging/discharging control unit 22 consumes the electric power of the battery pack 6 and discharge the battery pack 6 by utilizing the vehicle mounted electrical load 6, the electric type heater 15 or the electrical resistance, etc. of charger 31, or another dischargeable device, etc.

At step S27, the charging/discharging control unit 22 determines whether or not the detected SOC has reached the target SOC. That is, the charging/discharging control unit 22 determines whether or not the charging by step S25 or the discharging by step S25 has been completed. When determining that the detected SOC has reached the target SOC (target SOC=detected SOC), the charging/discharging control unit 22 concludes that the charging or discharging has been completed and proceeds the processing to step S28. Further, when determining that the detected SOC has not reached the target SOC (target SOC≠detected SOC), the charging/discharging control unit 22 concludes that the charging or discharging has not been completed and performs the processing from step S22 again.

At step S28, the charging/discharging control unit 22 enters the sleep mode. Then, the charging/discharging control unit 22 ends the processing shown in FIG. 4.

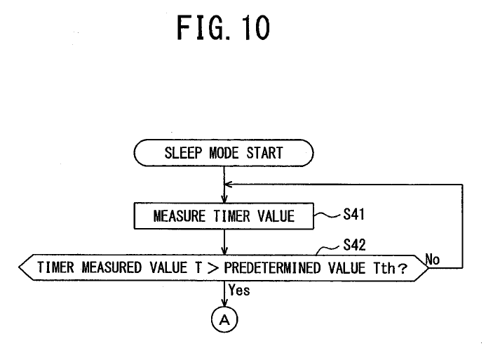

FIG. 10 is a flow chart for showing one example of the content of processing in the sleep mode.

As shown in FIG. 10, first, at step S41, the charging/discharging control unit 22 uses a timer to measure the time.

Next, at step S42, the charging/discharging control unit 22 determines whether or not the timer measured value T obtained at step S41 is larger than a preset value Tth. Here, the preset value Tth is a value set experimentally, empirically, or theoretically. When determining that the timer measured value T is larger than a preset value Tth (T>Tth), the charging/discharging control unit 22 performs the processing from step S22 of FIG. 4 again. Conversely, when determining that the timer measured value T is the preset predetermined value Tth or less (T≦Tth), the charging/discharging control unit 22 performs the processing from step S41 again.

Next, the optimal charge control by the charging/discharging control unit 22 at the time of the READY state will be explained.

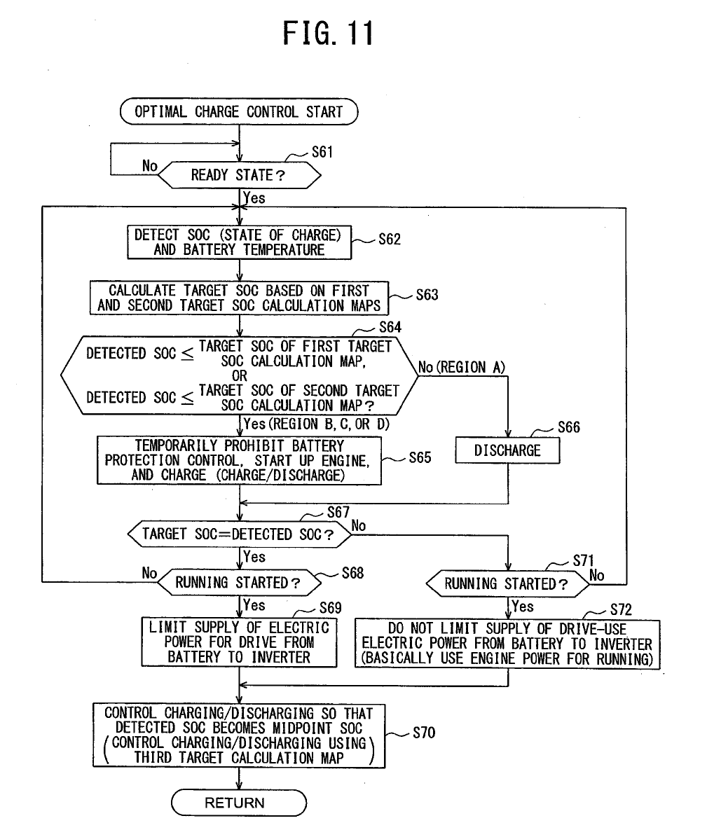

FIG. 11 is a flow chart showing one example of the content of processing of the optimal charge control.

As shown in FIG. 11, firstly, at step S61, the charging/discharging control unit 22 determines whether or not the state is the READY state.

Here, the hybrid electric vehicle 1 of the present embodiment mounts a keyless entry system or smart key system. It is possible to operate a button etc., without inserting a portable device (key) into the ignition cylinder. so as to set the vehicle in the READY state. By setting the READY state, the vehicle becomes capable of running.

The drive controller 9 determines whether or not the state is such a READY state. When determining that the state is the READY state, the drive controller 9 proceeds the processing to step S62.

At step S62, the charging/discharging control unit 22 detects the SOC (detected SOC) and battery temperature based on the detected value of the battery state detecting unit 34.

Next, at step S63, the charging/discharging control unit 22, in the same way at step S23 of FIG. 4, refers to the first target SOC calculation map 23a and the second target SOC calculation map 23b and acquires the target SOC corresponding to the battery temperature detected at step S62.

Next, at step S64, the charging/discharging control unit 22 determines whether or not the detected SOC is equal to or lower than the target SOC calculated at step S63 based on the first target SOC calculation map 23a or whether or not the detected SOC is equal to or lower than the target SOC calculated at step S63 based on the second target SOC calculation map 23b. When determining that the detected SOC is equal to or lower than the target SOC calculated based on the first target SOC calculation map 23a or when the detected SOC is equal to or lower than the target SOC calculated based on the second target SOC calculation map 23b, the charging/discharging control unit 22 proceeds the processing to step S65. Further, when determining that the detected SOC is not equal to or lower than the target SOC calculated based on the first target SOC calculation map 23a and is not equal to or lower than the target SOC calculated based on the second target SOC calculation map 23b, the charging/discharging control unit 22 proceeds the processing to step S66.

At step S65, the charging/discharging control unit 22 temporarily prohibits the battery protection control shown in FIG. 3 by the battery protection control unit 21, that is, temporarily releases the battery discharge lower limit voltage Vth and starts the engine 8 with the generator 7 to perform charging. Further, the charging/discharging control unit 22 proceeds the processing to step S67.

Here, when the detected SOC is present in the region C, the charging/discharging control unit 22, in the same way as the processing of FIG. 4, performs charging so that when the battery temperature at the time of detection of the detected SOC is equal to or lower than the intersecting battery temperature, the detected SOC becomes the target SOC of the first target SOC calculation map 23a. Additionally, the charging/discharging control unit 22, in the same way as the processing of FIG. 4, performs charging so that when the battery temperature at the time of detection of the detected SOC is higher than the intersecting battery temperature, the detected SOC becomes the target SOC of the second target SOC calculation map 23b. Furthermore, when the detected SOC is present in the region D, the charging/discharging control unit 22, in the same way as the processing of FIG. 4, performs charging so that the detected SOC becomes the target SOC of the second target SOC calculation map 23b.

On the other hand, when the detected SOC is present in the region B, the charging/discharging control unit 22, in the different way from the processing of FIG. 4, performs charging (discharging, in some cases) based on a third target SOC calculation map 23c shown in FIG. 5 by the one-dot chain line.

Here, the third target SOC calculation map 23c is a map in which the battery temperature and the target SOC are associated with each other in the same way as the first and second target SOC calculation maps 23a and 23b. In this third target SOC calculation map 23c, in the battery temperature region higher than the intersecting battery temperature (second temperature region), regardless of the battery temperature, the target SOC becomes a value between the target SOC of the first target SOC calculation map 23a and the target SOC of the second target SOC calculation map 23b (for example, the substantial midpoint or the approximate average value of the target SOC of the first target SOC calculation map 23a and the target SOC of the second target SOC calculation map 23b, hereinafter, referred to as “the midpoint”). Then, in this third target SOC calculation map 23c, at the temperature region where the battery temperature is a low temperature region (that is, first temperature region), the target SOC becomes a value close to the target SOC of the second target SOC calculation map 23b. Accordingly, the third target SOC calculation map 23c can be said to be a map which is mainly defined inside the region B.

When the detected SOC is present in the region B, the charging/discharging control unit 22 performs charging/discharging so that the detected SOC becomes the target SOC of this third target SOC calculation map 23c.

At step S66, the charging/discharging control unit 22 discharges the battery pack 6. Then, the charging/discharging control unit 22 proceeds the processing to step S67.

Here, the charging/discharging control unit 22, in the same way as the processing of FIG. 4, performs discharging so that when the battery temperature at the time of detection of the detected SOC is equal to or lower than the intersecting battery temperature, the detected SOC becomes the target SOC of the second target SOC calculation map 23b and performs discharging so that when the battery temperature at the time of detection of the detected SOC is higher than the intersecting battery temperature, the detected SOC becomes the target SOC of the first target SOC calculation map 23a.

At step S67, the charging/discharging control unit 22 determines whether or not the detected SOC has reached the target SOC. Here, when the detected SOC is present in the region B, the charging/discharging control unit 22 sets the target SOC to the midpoint SOC (SOC of third SOC calculation map 23c) and determines whether or not the detected SOC has reached such target SOC. When determining that the detected SOC has reached the target SOC (target SOC=detected SOC), the charging/discharging control unit 22 concludes that the charging of step S65 (discharging, in some cases) has been completed or that the discharging of step S66 has been completed and proceeds the processing to step S68. In addition, when determining that the detected SOC has not reached the target SOC (target SOC≠detected SOC), the charging/discharging control unit 22 concludes that the charging of step S65 (discharging, in some cases) has not been completed or that the discharging of step S66 has not been completed and proceeds the processing to step S71.

At step S68, the charging/discharging control unit 22 determines whether or not the vehicle has started running. When determining that the vehicle has started running, the charging/discharging control unit 22 proceeds the processing to step S69. In addition, when determining that the vehicle has not started running, the charging/discharging control unit 22 starts the processing from step S62 again.

At step S69, the charging/discharging control unit 22 performs processing to not limit the supply of the drive power from the battery pack 6 to the inverter 5. This makes the hybrid electric vehicle 1 causes the electric power from the battery pack 6 to drive the drive motor 4 and to make the vehicle run. Then, the charging/discharging control unit 22 proceeds the processing to step S70.

At step S71, the charging/discharging control unit 22 determines whether or not the vehicle has started running. For example, the charging/discharging control unit 22 determines that the vehicle has started running when the vehicle speed becomes higher than a preset vehicle speed. When determining that the vehicle has started running, the charging/discharging control unit 22 proceeds the processing to step S72. Additionally, when determining that the vehicle has not started running, the charging/discharging control unit 22 starts the processing from step S62 again.

At step S72, the charging/discharging control unit 22 regulates the supply of drive power from the battery pack 6 to the inverter 5. This makes the hybrid electric vehicle 1 use the engine power to make the vehicle run. For this reason, the charging/discharging control unit 22 drives the engine 8 and uses the power generated by the generator 7 to drive the drive motor 4 to make the vehicle run. Further, the charging/discharging control unit 22 proceeds the processing to step S70.

At step S70, the charging/discharging control unit 22 controls charging/discharging so that the detected SOC becomes the midpoint SOC (that is, target SOC of third target SOC calculation map 23c).

Specifically, when the charging/discharging control unit 22 performs the determination process at step S67 so as to perform the discharging control by matching the detected SOC present in the region A with the target SOC of the first target SOC calculation map 23a, the charging/discharging control unit 22 further performs discharging until the detected SOC becomes the midpoint SOC. Moreover, when the charging/discharging control unit 22 performs the determination process at step S67 so as to perform the discharging control by matching the detected SOC present in the region C with the target SOC of the second target SOC calculation map 23b, the charging/discharging control unit 22 further performs charging until the detected SOC becomes the midpoint SOC. Furthermore, the charging/discharging control unit 22 maintains the charging/discharging control when performing the determination process at step S67 so as to perform charging/discharging control by matching the detected SOC present in the region B with the midpoint SOC.

Note that, when the charging control is performed by matching the detected SOC which is present in the region D due to the determination process at step S67 with the target SOC of the second target SOC calculation map 23b, since the midpoint SOC is not defined in the region D, the charging/discharging control unit 22 maintains such a charged state.

Further, when the charging control is performed by matching the detected SOC which is present in the region C due to the battery temperature being equal to or lower than the intersecting battery temperature with the target SOC of the first target SOC calculation map 23a, it is also possible to further perform charging so that the detected SOC matches the target SOC of the second target SOC calculation map 23b corresponding to the same battery temperature.

### (Operation, Action, Etc.)

Next, an example of the operation of the vehicle controller 20 will be explained.

When the vehicle controller 20 determines that the charger 31 and the outside power source 100 are connected by the charging cable 32 and the detected SOC is equal to or lower than the target SOC calculated based on the first target SOC calculation map 23a or the detected SOC is equal to or lower than the target SOC calculated based on the second target SOC calculation map 23b, the vehicle controller 20 causes the charging unit 30 to charge the battery pack 6 (step S21 to step S25 and step S27).

Further, when the vehicle controller 20 determines that the charger 31 and the outside power source 100 are connected by the charging cable 32, but the detected SOC is not equal to or lower than the target SOC calculated based on the first target SOC calculation map 23a and the detected SOC is not equal to or lower than the target SOC calculated based on the second target SOC calculation map 23b, the vehicle controller 20 discharges the battery pack 6 (step S21 to step S24, step S26, and step S27).

Further, when the vehicle controller 20 shifts to the sleep mode, the above-mentioned charging or discharging ends, and a preset time elapses, the vehicle controller 20 again determines whether or not the detected SOC is the target SOC calculated from the first target SOC calculation map 23a or whether or not the detected SOC is the target SOC calculated from the second target SOC calculation map 23b, and performs charging or discharging in accordance with the determination result (FIG. 10 and FIG. 4).

Accordingly, when the vehicle controller 20 shifts to the sleep mode and a preset time elapses since when the above-mentioned charging or discharging ends, and when the battery temperature changes and therefore the detected SOC does not match the target SOC of the first target SOC calculation map 23a or second target SOC calculation map 23b, the vehicle controller 20 performs charging or discharging in accordance with the regions A, B, C, or D in which the detected SOC is present (FIG. 4).

Further, when the vehicle controller 20 determines that the state is the READY state (that is, state of being capable of running), and the detected SOC is equal to or lower than the target SOC calculated based on the first target SOC calculation map 23a, or the detected SOC is the target SOC calculated based on the second target SOC calculation map 23b, the vehicle controller 20 temporarily prohibits battery protection control and causes the generator 7 to start up the engine 8 and to perform charging (step S61 to step S65, and step S67).

Further, when the vehicle controller 20 determines that the state is the READY state, but the detected SOC is not equal to or lower than the target SOC calculated based on the first target SOC calculation map 23a and the detected SOC is not equal to or lower than the target SOC calculated based on the second target SOC calculation map 23b, the vehicle controller 20 discharges the battery pack 6 (step S61 to step S64, step S66, and step S67).

Further, when the vehicle controller 20 detects that the above-mentioned charging or discharging is completed and the vehicle is running, the vehicle controller 20 drives the drive motor 4 with the electric power from the battery pack 6 to make the vehicle run (step S67, step S71, and step S72). On the other hand, when the vehicle controller 20 detects that the vehicle is running before the above-mentioned charging or discharging is completed, the vehicle controller 20 drives the engine 8 and drives the drive motor 4 with the electric power generated by the generator 7 to make the vehicle run (step S67 to step S69). After that, while running the vehicle by driving the drive motor 4 with the electric power from the battery pack 6 or the electric power generated by the generator 7, the vehicle controller 20 controls charging/discharging so that the detected SOC becomes the midpoint SOC (step S70).

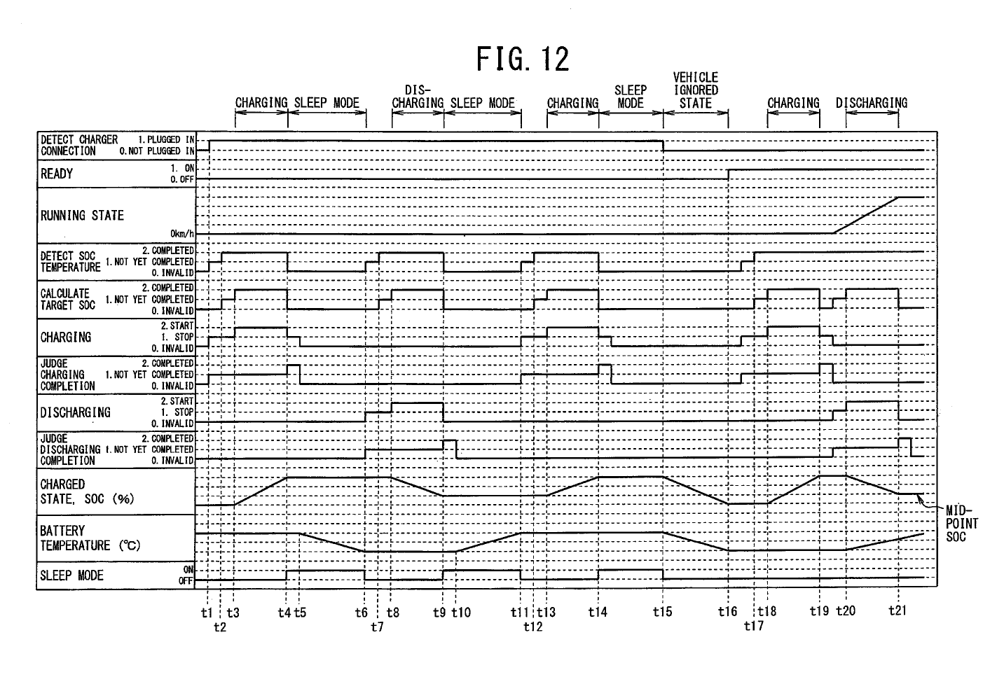

Further, FIG. 12 shows an example of a time chart at the time of optimal charge control.

As shown in FIG. 12, when the vehicle controller 20 detects connection to the charger 31 (that is, the fact that the charger 31 and the outside power source 100 are connected) (time t1), the vehicle controller 20 detects the SOC and battery temperature (time t2). Then, the vehicle controller 20 calculates the target SOC based on the battery temperature and first and second target SOC calculation maps 23a and 23b, and starts the charging base on the calculated target SOC and detected SOC (time t3). Due to this, from the time t3, the SOC of the battery pack 6 increases. Next, the vehicle controller 20 shifts to the sleep mode when the charging is completed (target SOC=detected SOC) (time t4). In this example, during the period of this sleep mode, the battery temperature starts to drop at the time t5.

In addition, when the sleep mode ends (time t6), the vehicle controller 20 again detects the SOC and battery temperature (time t7). Further, the vehicle controller 20 calculates the target SOC based on the battery temperature and first and second target SOC calculation maps 23a and 23b, start discharging based on the calculated target SOC and detected SOC (time t8). This decreases, from the time t8, the SOC of the battery pack 6. Moreover, when the discharging is completed (target SOC=detected SOC), the vehicle controller 20 again shifts to the sleep mode (time t9). In this example, during the period of this sleep mode, at the time t10, the battery temperature starts to increase.

Then, when the sleep mode ends (time t11), the vehicle controller 20 again detects the SOC and battery temperature (time t12). Subsequently, the vehicle controller 20 calculates the target SOC based on the battery temperature and the first and second target SOC calculation maps 23a and 23b, and starts charging based on the calculated target SOC and detected SOC (time t13). This increases the SOC of the battery pack 6 from the time t13. Then, the vehicle controller 20 shifts again to the sleep mode when the charging is completed (target SOC=detected SOC) (time t14).

Subsequently, when the vehicle controller 20 can no longer connection to the charger 31 (time t15), the hybrid electric vehicle 1 enters an ignored state.

After that, when detecting the READY state (time t16), the vehicle controller 20 detects the SOC and the battery temperature (time t17). Then, the vehicle controller 20 calculates the target SOC based on the battery temperature and first and second target SOC calculation maps 23a and 23b, and starts charging based on the calculated target SOC and detected SOC (time t18). This increases the SOC of the battery pack 6 from the time t18. In addition, when the charging is completed (target SOC=detected SOC, time t19), the vehicle controller 20 calculates the target SOC base on the battery temperature and third target SOC calculation map 23c and starts the discharging with the midpoint SOC used as the control target based on the calculated target SOC and detected SOC (t20). This decreases the SOC of the battery pack 6 from the time t20. The vehicle controller 20 ends the discharging when the detected SOC reaches the target SOC (the midpoint SOC) (time t21).

In the above way, in the present embodiment, the vehicle controller 20 has not only the first target SOC calculation map 23a set in consideration of the regenerative power generation and set for calculating the target SOC based on the battery temperature, but also the second target SOC calculation map 23b set in consideration of the startup property of the engine 8 (to enable the engine 8 to reliably start up) and set for calculating the target SOC based on the battery temperature. Further, the vehicle controller 20 calculates the target SOC based on these first and second target SOC calculation maps 23a and 23b and performs charging/discharging control based on the calculated target SOC as the control target.

For example, in some cases, the battery temperature of the battery pack 6 becomes low or the battery pack 6 is ignored for a long period of time and thereby the SOC of the battery pack 6 may become insufficient. In such cases, when the driver sets the vehicle in the READY state (that is, before starting running) and tries to start up the engine 8 (when the engine 8 is started up for being heated by heat of the engine 8 that is necessary), the vehicle may not be able to start up the engine 8.

As opposed to this, in the present embodiment, the vehicle controller 20 controls charging/discharging as a control target the target SOC calculated based on the second target SOC calculation map 23b set in consideration of the startup property of the engine 8 so can prevent the engine 8 from being unable to be started up.

Additionally, in the present embodiment, when the vehicle starts running after the charging or discharging is completed, the vehicle controller 20 drives the drive motor 4 with the electric power of the battery pack 6, and makes the vehicle run. On the other hand, when the vehicle starts running before the charging or discharging is completed, the vehicle controller 20 drives the engine 8 and drives the drive motor 4 with the electric power generated by the generator 7 to make the vehicle run.

Accordingly, in the present embodiment, it is possible to prevent the SOC of the battery pack 6 from falling drastically, since electric power of the battery pack 6 is consumed before the charging or discharging is completed.

### Modifications to Embodiment

In the present embodiment, application is also possible to a hybrid electric vehicle 1 which cannot use a commercial power source to charge the vehicle-mounted battery pack 6 (that is, a hybrid electric vehicle which is not a plug-in hybrid electric vehicle). In this case, the hybrid electric vehicle 1 performs only the optimal charge control at the time of the READY state as shown in FIG. 11.

Further, in the present embodiment, when the detected SOC is present in the region B, it is also possible not to perform the charging/discharging control using the third target SOC calculation map 23c. Also in this case, the SOC of the battery pack 6 is maintained in the region B so long as the pack is not charged or discharged by driving of the drive motor 4, etc.

Further, in the present embodiment, the optimal charge control at the time of the charging mode can be performed by the charging control unit 33 instead of the vehicle controller 20.

Further, in the present embodiment, the generator 7, for example, constitutes a first motor. In addition, the drive motor 4, for example, constitutes a second motor. Furthermore, the battery state detecting unit 34, for example, constitutes a temperature detecting unit and a SOC detecting unit. Moreover, the battery protection control unit 21 (one function of the vehicle controller 20), for example, constitutes an internal combustion engine startup prohibiting unit.

Further, while embodiments of the present invention were specifically explained, the scope of the present invention is not limited to the illustrated and described exemplary embodiments and includes all embodiments which give rise to advantageous effects which are equal to those which the present invention aims at. Furthermore, the scope of the present invention is not limited to combinations of features of the present invention which are defined in claim 1 and can be defined by desired combinations of specific features among all of the features which are disclosed.

### REFERENCE SIGNS LIST

1 hybrid electric vehicle, 4 drive motor, 6 battery pack, 7 generator, 8 engine, 20 vehicle controller, 21 battery protection control unit, 22 charging/discharging control unit, 23 storage unit, 23a first target SOC calculation map, 23b second target SOC calculation map, 23c third target SOC calculation map, 34 battery state detecting unit

1. A charging/discharging control apparatus for controlling charging/discharging of a battery in a vehicle having a first motor connected to an internal combustion engine to start the internal combustion engine and driven by the internal combustion engine to generate power, a battery for storing the power from the first motor, and a second motor connected to the drive wheels to drive the drive wheels with the power from the first motor or the battery and to generate a braking force at the drive wheels for regenerative power generation,
the charging/discharging control unit comprising:
a temperature detecting unit for detecting a temperature of the battery;
an SOC detecting unit for detecting a State Of Charge of the battery;
a storage unit for storing a first map in which a battery temperature and a target SOC for enabling the regenerative power generation at the battery temperature are associated with each other, and a second map in which the battery temperature and a target SOC for enabling startup of the internal combustion engine at the battery temperature are associated with each other; and
a charging/discharging control unit for acquiring the target SOC associated with the battery temperature detected by the temperature detecting unit based on the first map or the second map, and for controlling charging/discharging so that the SOC detected by the SOC detecting unit matches the acquired target SOC.

2. The charging/discharging control apparatus according to claim 1, further comprising an internal combustion engine startup prohibiting unit for prohibiting the startup of the internal combustion engine at the time of a low SOC,
wherein the internal combustion engine startup prohibiting unit acquires the target SOC associated with the battery temperature detected by the temperature detecting unit based on the first map or the second map, and allows the startup of the internal combustion engine when charging by the charging/discharging control is performed so that the SOC detected by the SOC detecting unit matches the acquired target SOC.

3. The charging/discharging control apparatus according to claim 1, wherein
between said first map and said second map, there is a part having a relationship in which the target SOC of the first map becomes larger than the target SOC of the second map,
the storage unit further stores a third map in which the battery temperature and a target SOC smaller than the target SOC of the first map and larger than the target SOC of the second map are associated with each other, and
the charging/discharging control unit controls charging/discharging to acquire the target SOC associated with the battery temperature detected by the temperature detecting unit based on the third map, so that the SOC detected by the SOC detecting unit matches the acquired target SOC, when the SOC detected by the SOC detecting unit is smaller than the target SOC of the first map and is larger than the target SOC of the second map.

4. The charging/discharging control apparatus according to claim 3, wherein
the first map and the second map intersect so that the target SOC of the first map becomes smaller than the target SOC of the second map in a first temperature region where the battery temperature is low, and the target SOC of the first map becomes larger than the target SOC of the second map in a second temperature region where the battery temperature is higher than the first temperature region, and
in the third map, the battery temperature of the second temperature region and the target SOC smaller than the target SOC of the first map and is larger than the target SOC of the second map are associated with each other.
